(19) United States
(12) Patent Application Publication
(10) Pub. No.: US 2022/0141894 A1
(43) Pub. Date: May 5, 2022

(54) TRIGGERING MIGRATION TO ENABLE INTER-DONOR TOPOLOGY ADAPTATION IN A WIRELESS NETWORK

(71) Applicant: QUALCOMM Incorporated, San Diego, CA (US)

(72) Inventors: Naeem AKL, Somerville, NJ (US); Karl Georg HAMPEL, Hoboken, NJ (US); Navid ABEDINI, Basking Ridge, NJ (US); Jianghong LUO, Skillman, NJ (US); Luca BLESSENT, Whitehouse Station, NJ (US); Junyi LI, Fairless Hills, PA (US); Tao LUO, San Diego, CA (US)

(21) Appl. No.: 17/452,924

(22) Filed: Oct. 29, 2021

Related U.S. Application Data
(60) Provisional application No. 63/198,667, filed on Nov. 2, 2020.

(51) Int. Cl. H04W 76/14; H04W 40/24; H04W 40/22

(52) U.S. Cl. CPC H04W 76/14; H04W 40/22; H04W 40/24

(57) ABSTRACT

Various aspects of the present disclosure generally relate to wireless communication. In some aspects, a source integrated access and backhaul (IAB) donor central unit (CU) may transmit, to an IAB node having a first signaling connection with the source IAB donor CU, a trigger to establish a second signaling connection between the IAB node and a target IAB donor CU. The source integrated access may transmit, to the IAB node, transport network layer address information associated with the target IAB donor CU to enable the IAB node to establish the second signaling connection with the target IAB donor CU. The IAB node may transmit, to the target IAB donor CU, a request to establish the second signaling connection with the target IAB donor CU based at least in part on the trigger. Numerous other aspects are provided.

### CROSS-REFERENCE TO RELATED APPLICATION

This patent application claims priority to U.S. Provisional Patent Application No. 63/198,667, filed on Nov. 2, 2020, entitled “TRIGGERING MIGRATION TO ENABLE INTER-DONOR TOPOLOGY ADAPTATION IN A WIRELESS NETWORK,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for triggering migration to enable inter-donor topology adaptation in a wireless network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a source integrated access and backhaul (IAB) donor central unit (CU) includes transmitting, to an IAB node having a first signaling connection with the source IAB donor CU, a trigger to establish a second signaling connection between the TAB node and a target IAB donor CU; and transmitting, to the IAB node, transport network layer (TNL) address information associated with the target TAB donor CU to enable the TAB node to establish the second signaling connection with the target IAB donor CU.

In some aspects, a method of wireless communication performed by an IAB node includes receiving, from a source IAB donor CU having a first signaling connection with the TAB node, a trigger to establish a second signaling connection with a target TAB donor CU; and transmitting, to the target TAB donor CU, a request to establish the second signaling connection with the target TAB donor CU based at least in part on the trigger.

In some aspects, a source IAB donor CU for wireless communication includes a memory and one or more processors, coupled to the memory, configured to: transmit, to an IAB node having a first signaling connection with the source IAB donor CU, a trigger to establish a second signaling connection between the IAB node and a target IAB donor CU; and transmit, to the IAB node, TNL address information associated with the target IAB donor CU to enable the IAB node to establish the second signaling connection with the target IAB donor CU.

In some aspects, an IAB node for wireless communication includes a memory and one or more processors, coupled to the memory, configured to: receive, from a source IAB donor CU having a first signaling connection with the IAB node, a trigger to establish a second signaling connection with a target IAB donor CU; and transmit, to the target IAB donor CU, a request to establish the second signaling connection with the target IAB donor CU based at least in part on the trigger.

In some aspects, a non-transitory computer-readable medium storing a set of instructions for wireless communication includes one or more instructions that, when executed by one or more processors of a source IAB donor CU, cause the source IAB donor CU to: transmit, to an IAB node having a first signaling connection with the source IAB donor CU, a trigger to establish a second signaling connection between the IAB node and a target IAB donor CU; and transmit, to the IAB node, TNL address information associated with the target IAB donor CU to enable the IAB node to establish the second signaling connection with the target IAB donor CU.

In some aspects, a non-transitory computer-readable medium storing a set of instructions for wireless communication includes one or more instructions that, when executed by one or more processors of an IAB node, cause the IAB node to: receive, from a source IAB donor CU having a first signaling connection with the IAB node, a trigger to establish a second signaling connection with a target IAB donor CU; and transmit, to the target IAB donor CU, a request to establish the second signaling connection with the target IAB donor CU based at least in part on the trigger.

In some aspects, an apparatus for wireless communication includes means for transmitting, to an IAB node having a first signaling connection with the apparatus, a trigger to establish a second signaling connection between the IAB node and a target IAB donor CU; and means for transmitting, to the IAB node, TNL address information associated with the target IAB donor CU to enable the IAB node to establish the second signaling connection with the target IAB donor CU.

In some aspects, an apparatus for wireless communication includes means for receiving, from a source IAB donor CU having a first signaling connection with the apparatus, a trigger to establish a second signaling connection with a target IAB donor CU; and means for transmitting, to the target IAB donor CU, a request to establish the second signaling connection with the target IAB donor CU based at least in part on the trigger.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processors, interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of radio access networks, in accordance with the present disclosure.

FIG. 4 is a diagram illustrating an example of an integrated access and backhaul (IAB) network architecture, in accordance with the present disclosure.

FIG. 5 is a diagram illustrating an example of an IAB network architecture and an example of a procedure to establish an F1 signaling connection between a distributed unit and a central unit in a wireless network, in accordance with the present disclosure.

FIG. 6 is a diagram illustrating an example of inter-donor topology adaptation in an IAB network, in accordance with the present disclosure.

FIGS. 7A-7B are diagrams illustrating examples associated with gradual inter-donor migration to adapt a topology in an IAB network, in accordance with the present disclosure.

FIG. 8 is a diagram illustrating an example associated with triggering migration to enable inter-donor topology adaptation in a wireless network, in accordance with the present disclosure.

FIGS. 9-10 are diagrams illustrating example processes associated with triggering migration to enable inter-donor topology adaptation in a wireless network, in accordance with the present disclosure.

FIGS. 11-12 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

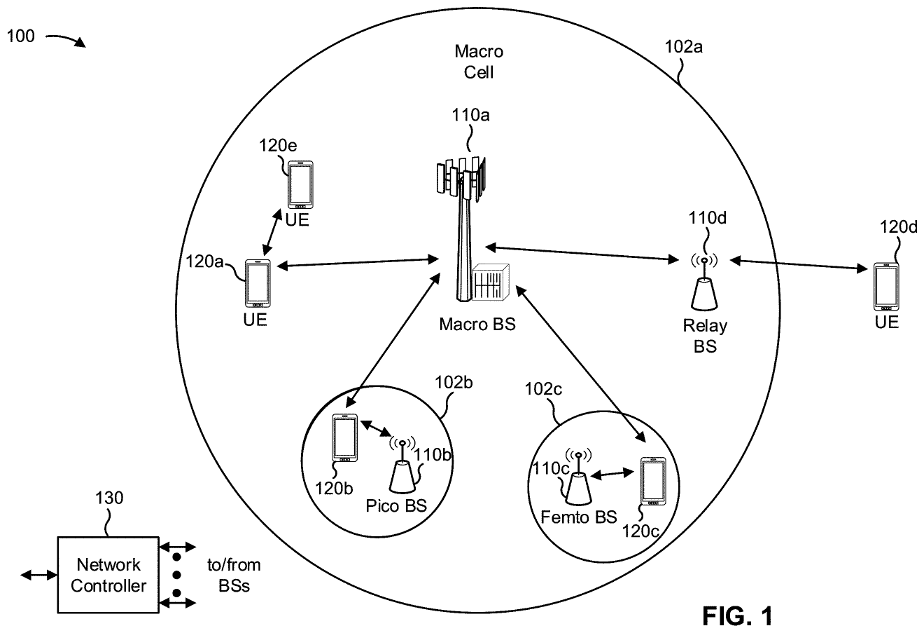

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

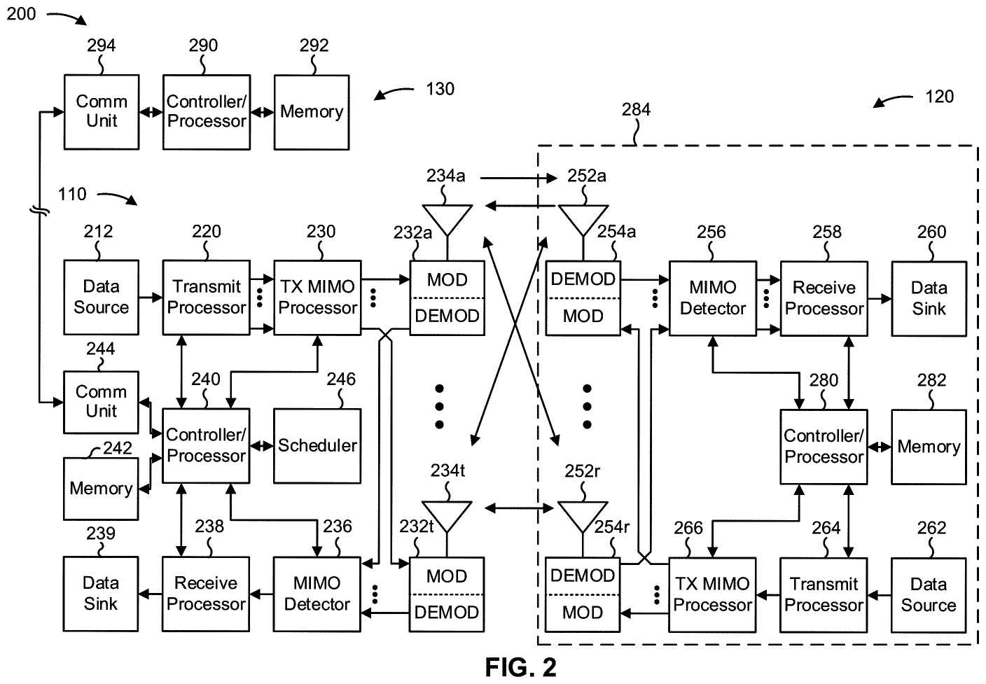

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

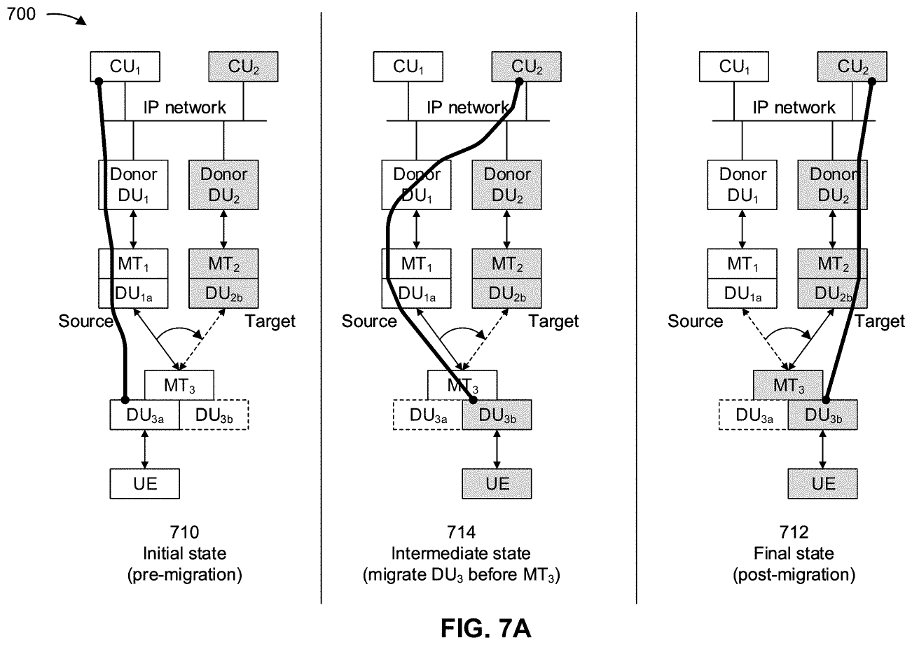

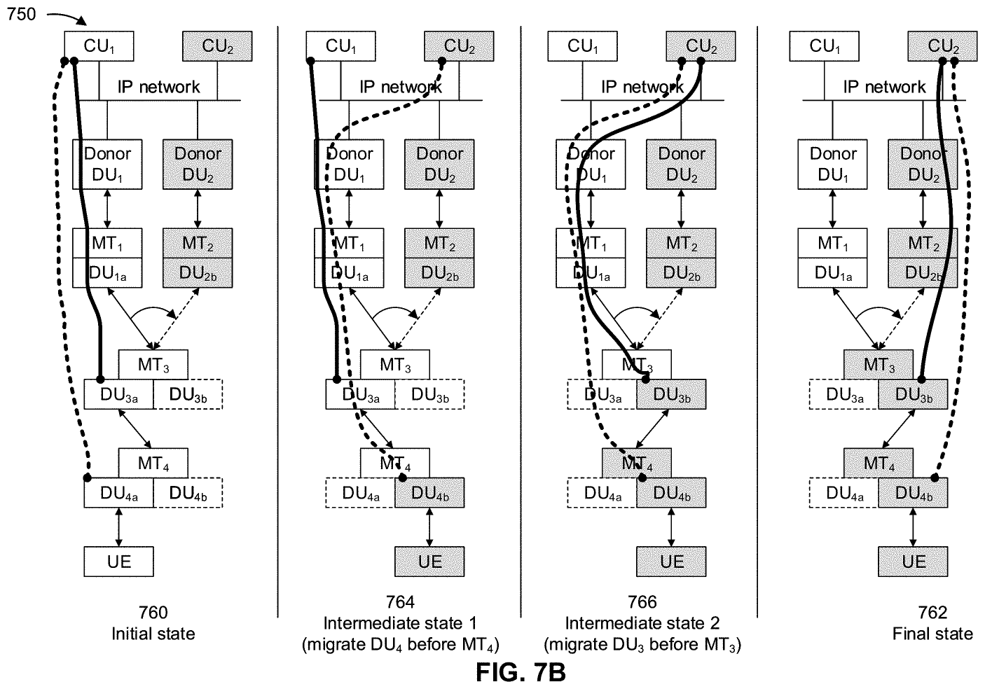

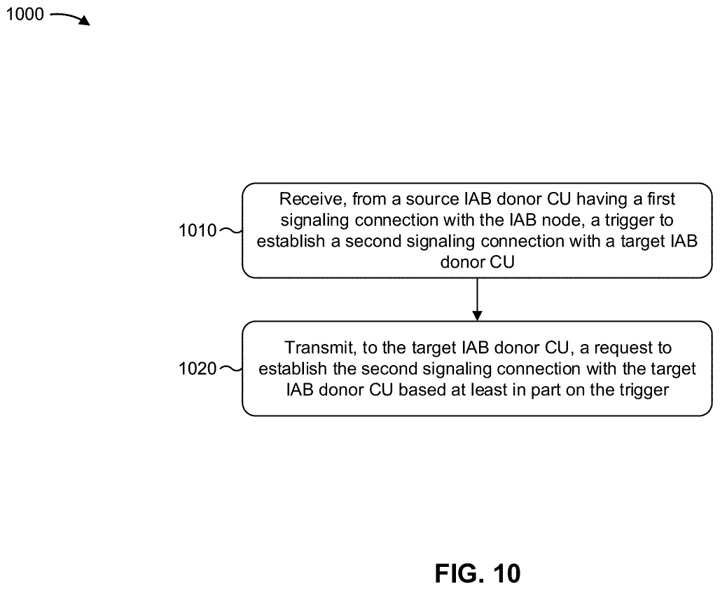

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 7A-7B, FIG. 8, FIG. 9, and/or FIG. 10).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 7A-7B, FIG. 8, FIG. 9, and/or FIG. 10).

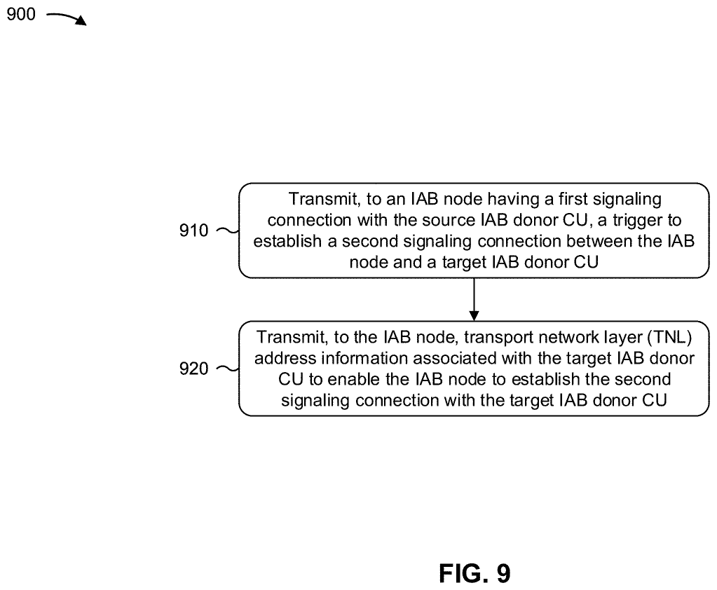

Controller/processor 240 of base station 110, controller/processor 280 of UE 120, and/or any other component(s) of FIG. 2 may perform one or more techniques associated with triggering migration to enable inter-donor topology adaptation in a wireless network, as described in more detail elsewhere herein. For example, controller/processor 240 of base station 110, controller/processor 280 of UE 120, and/or any other component(s) of FIG. 2 may perform or direct operations of, for example, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some aspects, executing instructions may include running the instructions, converting the instructions, compiling the instructions, and/or interpreting the instructions, among other examples.

In some aspects, a source integrated access and backhaul (IAB) donor central unit (CU) includes means for transmitting, to an IAB node having a first signaling connection with the source IAB donor CU, a trigger to establish a second signaling connection between the IAB node and a target IAB donor CU and/or means for transmitting, to the IAB node, transport network layer (TNL) address information associated with the target IAB donor CU to enable the IAB node to establish the second signaling connection with the target IAB donor CU. In some aspects, an IAB donor CU as described herein is the base station 110, is included in the base station 110, or includes one or more components of the base station 110 shown in FIG. 2. Accordingly, in some aspects, the means for the source integrated access to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the source IAB donor CU includes means for transmitting, to the IAB node, information indicating whether the TNL address information is associated with F1-C traffic, F1-U traffic, or non-F1 traffic.

In some aspects, the source IAB donor CU includes means for receiving the TNL address information from the target IAB donor CU.

In some aspects, the source IAB donor CU includes means for transmitting, to the target IAB donor CU, a request for the TNL address information, wherein the TNL address information is received from the target IAB donor CU based at least in part on the request.

In some aspects, the source IAB donor CU includes means for communicating with the target IAB donor CU to establish a usage associated with the TNL address information.

In some aspects, the source IAB donor CU includes means for receiving a request for the TNL address information from the IAB node over the first signaling connection.

In some aspects, an IAB node includes means for receiving, from a source IAB donor CU having a first signaling connection with the IAB node, a trigger to establish a second signaling connection with a target IAB donor CU; and/or means for transmitting, to the target IAB donor CU, a request to establish the second signaling connection with the target IAB donor CU based at least in part on the trigger. In some aspects, an IAB node as described herein is the base station 110 and/or the UE 120, is included in the base station 110 and/or the UE 120, or includes one or more components of the base station 110 and/or the UE 120 shown in FIG. 2. Accordingly, in some aspects, the means for the IAB node to perform operations described herein may include, for example, one or more of transmit processor 220, TX MIMO processor 230, modulator 232, antenna 234, demodulator 232, MIMO detector 236, receive processor 238, controller/processor 240, memory 242, scheduler 246, antenna 252, demodulator 254, MIMO detector 256, receive processor 258, transmit processor 264, TX MIMO processor 266, modulator 254, controller/processor 280, or memory 282.

In some aspects, the IAB node includes means for receiving, from the source IAB donor CU, TNL address information associated with the target IAB donor CU over the first signaling connection, wherein the TNL address information is used to establish the second signaling connection with the target IAB donor CU.

In some aspects, the IAB node includes means for receiving, from the source IAB donor CU, information indicating whether the TNL address information is associated with F1-C traffic, F1-U traffic, or non-F1 traffic.

In some aspects, the IAB node includes means for transmitting a request for the TNL address information to the source IAB donor CU over the first signaling connection.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

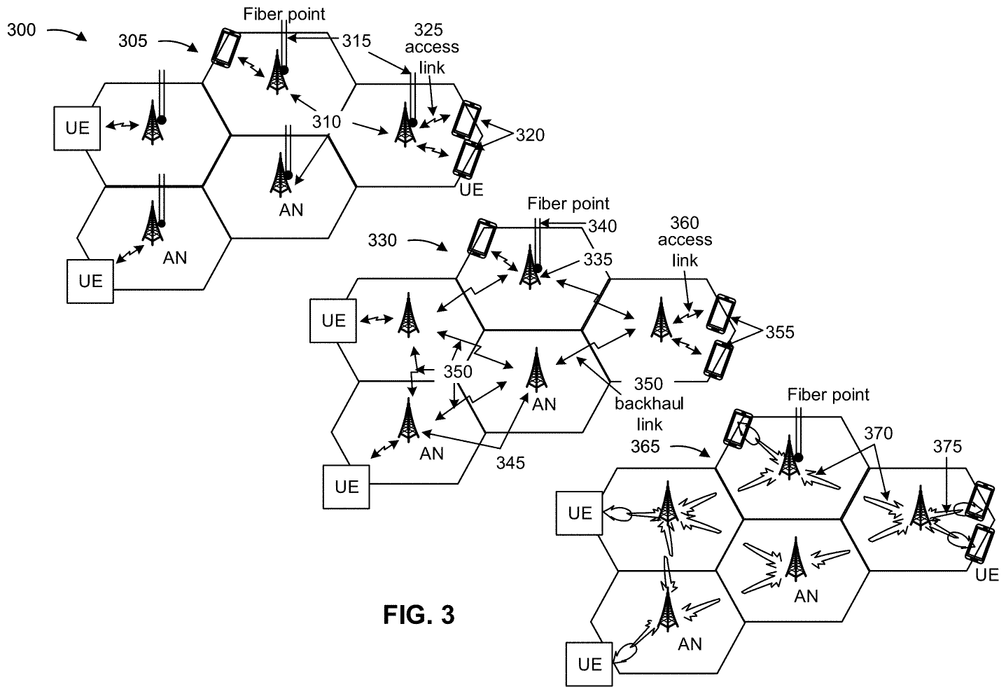

FIG. 3 is a diagram illustrating examples 300 of radio access networks, in accordance with the present disclosure.

As shown by reference number 305, a traditional (e.g., 3G, 4G, LTE, and/or the like) radio access network (RAN) may include multiple base stations 310 (e.g., access nodes (AN)), where each base station 310 communicates with a core network via a wired backhaul link 315, such as a fiber connection. A base station 310 may communicate with a UE 320 via an access link 325, which may be a wireless link. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a RAN may include a wireless backhaul network, sometimes referred to as an integrated access and backhaul (IAB) network. In an IAB network, at least one base station is an anchor base station 335 that communicates with a core network via a wired backhaul link 340, such as a fiber connection. An anchor base station 335 that has a wireline connection to a core network may also be referred to as an IAB donor (or IAB-donor). The IAB network may include one or more non-anchor base stations 345, sometimes referred to as relay base stations or IAB nodes (or IAB-nodes). The non-anchor base station(s) 345 may communicate directly or indirectly with the anchor base station 335 via one or more backhaul links 350 (e.g., via one or more non-anchor base stations 345) to form a backhaul path to the core network for carrying backhaul traffic. Backhaul link 350 may be a wireless link. Anchor base station(s) 335 and/or non-anchor base station(s) 345 may communicate with one or more UEs 355 via access links 360, which may be wireless links for carrying access traffic. In some aspects, an anchor base station 335 and/or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a RAN that includes an IAB network may utilize millimeter wave technology and/or directional communications (e.g., beamforming) for communications between base stations and/or UEs (e.g., between two base stations, between two UEs, and/or between a base station and a UE). For example, wireless backhaul links 370 between base stations may use millimeter wave signals to carry information and/or may be directed toward a target base station using beamforming. Similarly, the wireless access links 375 between a UE and a base station may use millimeter wave signals and/or may be directed toward a target wireless node (e.g., a UE and/or a base station). In this way, inter-link interference (e.g., due to spectrum sharing between the wireless access links 375 and the wireless backhaul links 370) may be reduced.

The configuration of base stations and UEs in FIG. 3 is shown as an example, and other examples are contemplated. For example, one or more base stations illustrated in FIG. 3 may be replaced by one or more UEs that communicate via a UE-to-UE access network (e.g., a peer-to-peer network, a device-to-device network, and/or another suitable UE-to-UE access network). In this case, “anchor node” may refer to a UE that is directly in communication with a base station (e.g., an anchor base station or a non-anchor base station).

As indicated above, FIG. 3 is provided as an example. Other examples may differ from what is described with regard to FIG. 3.

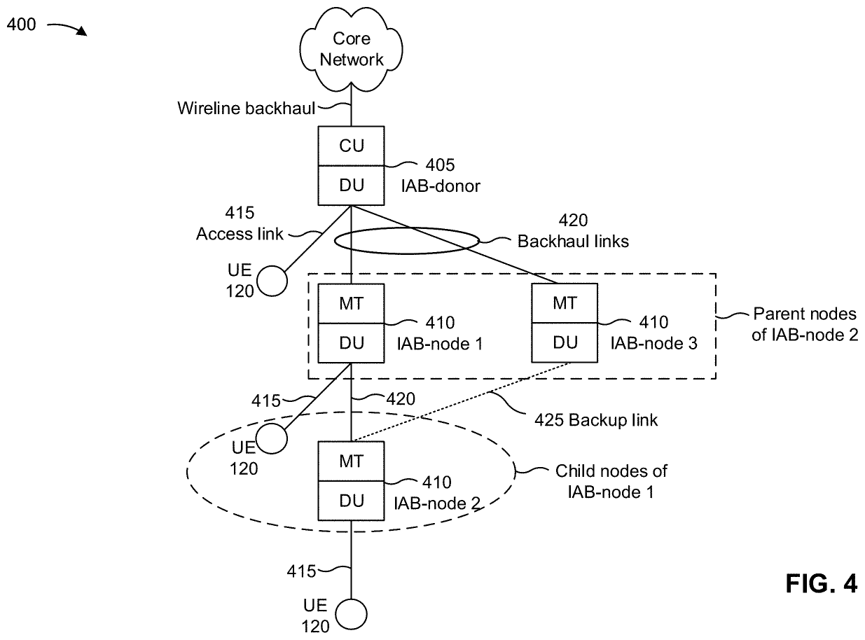

FIG. 4 is a diagram illustrating an example 400 of an IAB network architecture, in accordance with various the present disclosure.

As shown in FIG. 4, an IAB network may include an IAB donor 405 (shown as IAB-donor) that connects to a core network via a wired connection (shown as a wireline backhaul). For example, an NG interface of an IAB donor 405 may terminate at a core network. Additionally, or alternatively, an IAB donor 405 may connect to one or more devices of the core network that provide a core access and mobility management function (e.g., AMF). In some aspects, an IAB donor 405 may include a base station 110, such as an anchor base station, as described above in connection with FIG. 3. As shown, an IAB donor 405 may include a central unit (CU), which may perform access node controller (ANC) functions, AMF functions, and/or the like. The CU may configure a distributed unit (DU) of the IAB donor 405 and/or may configure one or more IAB nodes 410 (e.g., an MT and/or a DU of an IAB node 410) that connect to the core network via the IAB donor 405. Thus, a CU of an IAB donor 405 may control and/or configure the entire IAB network that connects to the core network via the IAB donor 405, such as by using control messages and/or configuration messages (e.g., a radio resource control (RRC) configuration message, an F1 application protocol (F1AP) message, and/or the like). Accordingly, the CU of the IAB donor 405 may hold RRC and packet data convergence protocol (PDCP) layer functions to control and/or configure the entire IAB network, and the DU of the IAB donor 405 may hold radio link control (RLC), medium access control (MAC), and physical (PHY) layer functions to act as a scheduling node that schedules child nodes of the IAB donor 405.

As further shown in FIG. 4, the IAB network may include one or more IAB nodes 410 (shown as IAB-node 1, IAB-node 2, and IAB-node 3) that connect to the core network via the IAB donor 405. As shown, an IAB node 410 may be a Layer-2 (L2) relay node that includes mobile termination (MT) functions (sometimes referred to as UE functions (UEF)) and DU functions (sometimes referred to as access node functions (ANF)). The MT functions of an IAB node 410 (e.g., a child node) may be controlled and/or scheduled by another IAB node 410 (e.g., a parent node of the child node) and/or by an IAB donor 405. The DU functions of an IAB node 410 (e.g., a parent node) may control and/or schedule other IAB nodes 410 (e.g., child nodes of the parent node) and/or UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, and/or schedule communications of IAB nodes 410 and/or UEs 120. A UE 120 may include only MT functions, and not DU functions. That is, communications of a UE 120 may be controlled and/or scheduled by an IAB donor 405 and/or an IAB node 410 (e.g., a parent node of the UE 120).

When a first node controls and/or schedules communications for a second node (e.g., when the first node provides DU functions for the MT functions of the second node), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 405 or an IAB node 410, and a child node may be an IAB node 410 or a UE 120. Communications of an MT function of a child node may be controlled and/or scheduled by a parent node of the child node.

As further shown in FIG. 4, a link between a UE 120 (e.g., which only has MT functions, and not DU functions) and an IAB donor 405, or between a UE 120 and an IAB node 410, may be referred to as an access link 415. An access link 415 may be a wireless access link that provides a UE 120 with radio access to a core network via an IAB donor 405, and optionally via one or more IAB nodes 410. Thus, the network illustrated in FIG. 4 may be referred to as a multi-hop network or a wireless multi-hop network.

As further shown in FIG. 4, a link between an IAB donor 405 and an IAB node 410 or between two IAB nodes 410 may be referred to as a backhaul link 420. A backhaul link 420 may be a wireless backhaul link that provides an IAB node 410 with radio access to a core network via an IAB donor 405, and optionally via one or more other IAB nodes 410. In an IAB network, network resources for wireless communications (e.g., time resources, frequency resources, spatial resources, and/or the like) may be shared between access links 415 and backhaul links 420. In some aspects, a backhaul link 420 may be a primary backhaul link or a secondary backhaul link (e.g., a backup backhaul link). In some aspects, a secondary backhaul link may be used if a primary backhaul link fails, becomes congested, becomes overloaded, and/or the like. For example, a backup link 425 between IAB-node 2 and IAB-node 3 may be used for backhaul communications if a primary backhaul link between IAB-node 2 and IAB-node 1 fails. As used herein, “node” or “wireless node” may refer to an IAB donor 405 or an IAB node 410.

As indicated above, FIG. 4 is provided as an example. Other examples may differ from what is described with regard to FIG. 4.

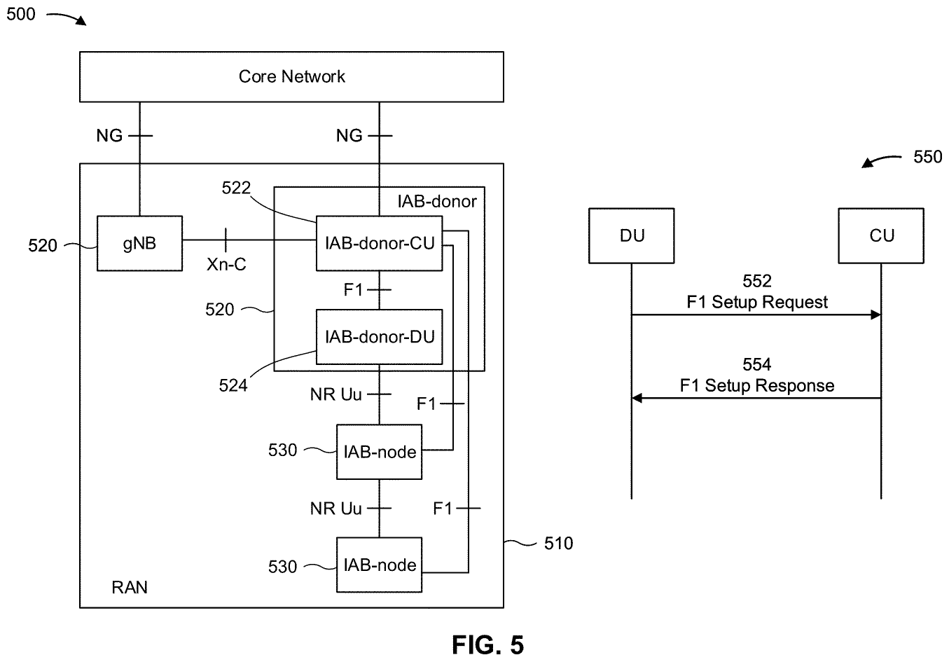

FIG. 5 is a diagram illustrating an example 500 of an IAB network architecture and an example 550 of a procedure to establish an F1 signaling connection between a DU and a CU in a wireless network, in accordance with the present disclosure.

As shown in FIG. 5, a RAN 510 may include one or more base stations 520 that communicate over a base station interface (e.g., an Xn or X2 interface) and have NG interfaces that terminate at a core network. Furthermore, as shown, the RAN 510 may include at least one base station 520 configured as an IAB donor that includes an IAB donor CU 522 to configure and/or otherwise control descendant nodes (e.g., child nodes, grandchild nodes, and/or the like) that access the core network through the IAB donor. As further shown, the at least one base station 520 that is configured as an IAB donor may also include an IAB donor DU 524 to act as a scheduling node that schedules the descendant nodes of the IAB donor. In this case, the IAB donor CU 522 may provide the NG interface to the core network, may communicate with other base stations 520 over an Xn control plane (Xn-C) interface, and may exchange F1 control plane (F1-C) traffic and/or F1 user plane (F1-U) traffic with the IAB donor DU 524 over an F1 interface, among other examples.

In some aspects, as further shown in FIG. 5, the RAN 510 may support an IAB topology by enabling one or more IAB nodes 530 to wirelessly connect to the at least one base station 520 that is configured as the IAB donor. For example, an IAB node 530 may include an MT unit that connects to the IAB donor DU 524 or to a DU of an upstream IAB node 530 via one or more UE functions associated with an NR Uu interface (e.g., an access interface). In addition, as described above, an IAB node 530 may include a DU unit that connects to one or more scheduled nodes (e.g., one or more downstream IAB nodes 530 and/or one or more served UEs 120) via one or more base station functions associated with the NR Uu interface. Furthermore, F1-C traffic and F1-U traffic between an IAB node 530 and the IAB donor CU 522 may be backhauled over F1 interface via the IAB donor DU 524 (and any optional intermediate hop IAB node(s) 530). Accordingly, in order to enable communication between the IAB donor DU 524 and the MT units of one or more downstream IAB nodes 530 over the NR Uu interface, an F1 connection may be established between the IAB donor CU 522 and the DU associated with each downstream IAB node 530. In other words, an F1 connection is established between the IAB donor CU 522 and each DU served by the IAB donor CU 522 (e.g., the IAB donor DU 524 and the DU of each downstream IAB node 530).

For example, FIG. 5 illustrates an example 550 of an F1 setup procedure to establish an F1 signaling connection between a DU and a CU in a wireless network (e.g., a wireless access network and/or an IAB network, among other examples). As described herein, the F1 setup procedure may be performed between any suitable base station DU (e.g., a DU of a gNB, an IAB donor DU 524, and/or a DU of an IAB node 530, among other examples) and any suitable base station CU (e.g., a CU of a gNB and/or an IAB donor CU 522, among other examples).

As shown in FIG. 5, and by reference number 552, the DU may transmit an F1 setup request message to the CU to initiate the F1 setup procedure. For example, the F1 setup request message may indicate one or more serving cells associated with the DU that are configured and ready to be activated, where each serving cell may be identified according to an identifier pair (e.g., a cell global identity (CGI) and a physical cell identity (PCI) pair). As further shown in FIG. 5, and by reference number 554, the CU transmit an F1 setup response message to the DU to establish the F1 connection between the DU and the CU and optionally indicate a list of one or more serving cells to be activated. Accordingly, after the F1 connection has been established, traffic communicated over the F1 interface may be associated with F1AP services that are divided into non-UE associated services and UE-associated services. For example, the traffic associated with the non-UE associated services may be used to manage the F1 connection and is unrelated to any UEs served by the DU, and the traffic associated with the UE-associated services may be associated with particular UEs and/or MT units of IAB nodes 530 served by the DU.

In some aspects, prior to the DU transmitting the F1 setup request message to initiate the F1 setup procedure, the DU and the serving cells associated with the DU may be configured by an operations, administration, and management (OAM) entity in an F1 pre-operational state. For example, in order to transmit the F1 setup request message at the application layer to establish the F1 connection to the CU, the DU may need to have transport network layer (TNL) connectivity (e.g., Internet Protocol (IP) connectivity) towards the CU. Accordingly, in the F1 pre-operational state, the OAM entity may configure TNL connectivity between the DU and the CU, and the F1 setup procedure may be the first F1AP procedure that is triggered for an F1-C interface after a TNL association between the DU and the CU has become operational.

For example, stream control transmission protocol (SCTP) may be supported as a transport layer for an F1-C signaling bearer between the DU and the CU, which may generally support a configuration with at least a one SCTP association per DU-CU pair. Furthermore, in some cases, configurations with multiple SCTP endpoints per DU-CU pair may be supported. In cases where configurations with multiple SCTP associations are supported, the CU and/or the DU may request to dynamically add and/or remove SCTP associations between the DU-CU pair. For example, an SCTP endpoint may correspond to an IP address at the DU, and another SCTP endpoint may correspond to an IP address at the CU. Between two SCTP endpoints, an SCTP association may be established, and the F1-C connection can then be established by exchanging an F1 setup request message and an F1 setup response message between the DU and the CU in the manner described above. Furthermore, in some cases, transport network redundancy may be achieved by SCTP multi-homing between the DU and the CU, where one or both of the DU and the CU is assigned with multiple IP addresses. For example, in a case where the CU is assigned five (5) IP addresses and the DU is assigned three (3) IP addresses, up to fifteen (15) SCTP associations can be established between the DU and the CU, and the F1AP signaling (e.g., the F1 setup request and F1 setup response) can be exchanged over any of the 15 SCTP associations. In this way, if one or more SCTP associations fail, other SCTP associations may remain available.

As indicated above, FIG. 5 is provided as an example. Other examples may differ from what is described with regard to FIG. 5.

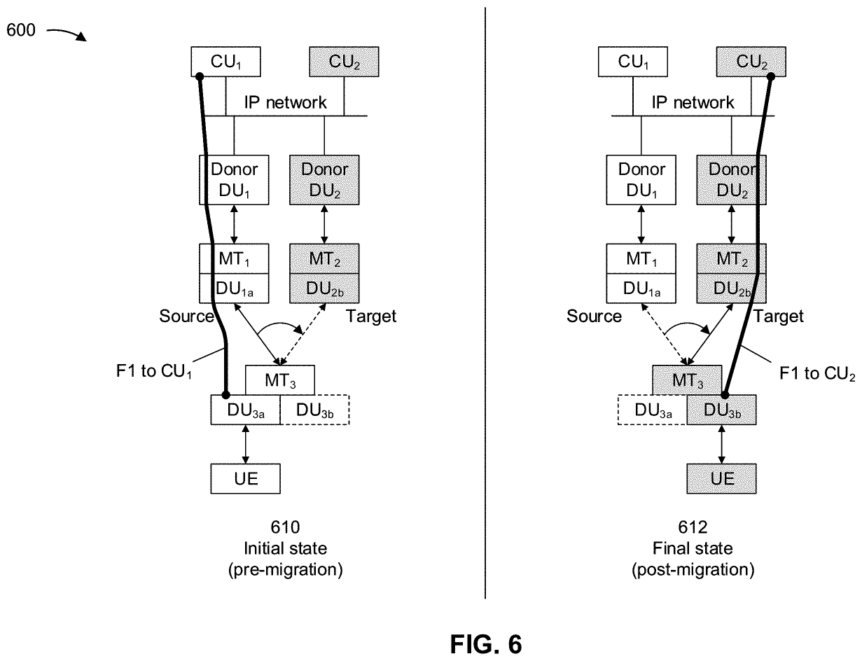

FIG. 6 is a diagram illustrating an example 600 of inter-donor topology adaptation in an IAB network, in accordance with the present disclosure.

As shown by reference number 610, in an initial (pre-migration) state, a UE may be served by an IAB node that includes a DU (shown as DU₃ₐ) having an F1 connection to a source IAB donor CU (shown as CU₁) and an MT (shown as MT₃) that communicates with a DU of a parent node (e.g., an intermediate upstream IAB node, shown as including MT₁ and DU₁ₐ) over a Uu interface. In some cases, the IAB node may be migrated to a different parent DU (e.g., from a source parent DU to a target parent DU) that is under the control of a different IAB donor CU (e.g., from DU₁ₐ under the control of CU₁ to DU_{2b} under the control of CU₂). In general, when an IAB node is migrated from a source IAB donor CU (e.g., CU₁) to a target IAB donor CU (e.g., CU₂), any child nodes of the IAB node (e.g., served UEs and/or child IAB nodes) may be migrated to the target IAB donor CU along with the migrating IAB node.

For example, in the initial (pre-migration) state shown in FIG. 6, the migrating IAB node includes MT₃ and DU₃ₐ serving the UE, which are connected to source IAB donor CU₁. In the pre-migration state, F1-U traffic associated with the UE flows on a source path (e.g., a source signaling connection, such as an F1 connection, between the serving DU and the source IAB donor CU). As further shown by reference number 612, in the final (post-migration) state, the migrating IAB node including MT₃ and a logical DU (shown as DU_{3b}) and the UE served by the migrating IAB node are both connected to the target IAB donor CU, and F1-U traffic associated with the UE flows on the target path (e.g., a target signaling connection, such as an F1 connection, between DU_{3b} and the target IAB donor CU). Accordingly, because an IAB node is generally migrated to a different IAB donor CU along with any descendant nodes (e.g., served UEs and/or downstream IAB nodes), inter-donor topology adaptation may cause a signaling storm, especially in cases where the migrating IAB node is associated with a large sub-tree and many UEs and/or descendant nodes need to be migrated.

For example, when the MT of the migrating IAB node (MT₃) switches from the source IAB donor CU (CU₁) to the target IAB donor CU (CU₂), all nodes under the MT of the migrating IAB node may be migrated in a controlled manner without sending every node into radio link failure. Accordingly, in order to migrate the IAB node that includes MT₃ to the target IAB donor CU, the source IAB donor CU first sends a context for the UE to the target IAB donor CU, the target IAB donor CU then establishes a context for the UE at the serving parent DU (DU_{3b}), the target IAB donor CU then acknowledges the handover message from the source IAB donor CU, the source IAB donor CU then sends a handover command message to the UE through the source path, and the UE then performs synchronization with the target serving parent DU. Accordingly, significant signaling may be needed to migrate a single UE from the source IAB donor CU to the target IAB donor CU, and the signaling may be multiplied for each node (e.g., MT, DU, and/or UE) in the sub-tree associated with the migrating IAB node. Some aspects described herein therefore provide a gradual inter-donor topology adaptation procedure, whereby nodes in a sub-tree associated with an IAB node migrating from a source IAB donor CU to a target IAB donor CU are gradually migrated to the target IAB donor CU. For example, some aspects described herein relate to gradual inter-donor topology adaptation that may be performed in a bottom-up manner, where a DU of an IAB node may be migrated from a source IAB donor CU to a target IAB donor CU before an MT of the IAB is migrated from the source IAB donor CU to the target IAB donor CU. Additionally, or alternatively, the gradual inter-donor topology adaptation described herein may be performed in a top-down manner, where an MT of an IAB node is migrated from a source IAB donor CU to a target IAB donor CU and a DU of the IAB is subsequently migrated from the source IAB donor CU to the target IAB donor CU. In this way, by enabling gradual inter-donor migration in an IAB network, the signaling associated with migrating one or more nodes in a sub-tree associated with a migrating IAB node may be spread out over time, which improves efficiency and/or utilization in the IAB network, reduces signaling overhead, and/or reduces processing at the source and/or target IAB donor CU, among other examples. Further details relating to gradual inter-donor migration are provided below with reference to FIGS. 7A-7B.

As indicated above, FIG. 6 is provided as an example. Other examples may differ from what is described with regard to FIG. 6.

FIGS. 7A-7B are diagrams illustrating examples 700, 750 associated with gradual inter-donor migration to adapt a topology in an IAB network, in accordance with the present disclosure.

As shown by example 700 in FIG. 7A, in an initial (pre-migration) state 710, a migrating IAB node includes a migrating IAB-MT (MT₃) and a migrating IAB-DU (DU₃ₐ) serving a UE, which are connected to a source IAB donor CU (CU₁). In the initial pre-migration state 710, F1-U traffic associated with the UE flows on a source path (e.g., an F1 connection) between the serving IAB-DU and the source IAB donor CU. As further shown in FIG. 7A, in a final (post-migration) state 712, the migrating IAB node including the associated IAB-MT and the associated logical IAB-DU (shown as DU_{3b}) and the UE served by the migrating IAB node are both connected to the target IAB donor CU, and F1-U traffic associated with the UE flows on the target path (e.g., an F1 connection) between the migrated IAB-DU and the target IAB donor CU. Furthermore, because concurrently migrating an IAB node and any descendant nodes in a sub-tree associated with the migrating IAB node may cause a signaling storm, one or more intermediate states 714 may be used to gradually migrate served UEs and/or descendant IAB nodes in the sub-tree associated with the migrating IAB node.

For example, in the intermediate state 714 shown in FIG. 7A, the migrating IAB node may include a migrating IAB-MT (MT₃), which be connected to a different IAB donor than one or more UEs and/or descendant IAB-MTs in the sub-tree associated with the migrating IAB-MT. For example, while the migrating IAB-MT is connected to the source IAB donor CU, the UE may connect to the target IAB donor CU, and F1-U traffic for the UE flows on the source path between the target IAB donor CU and the target logical IAB-DU associated with the migrating IAB node. The migrating IAB-MT may then be migrated to the target IAB donor CU at a later time (e.g., 30 minutes or an hour after the UE and the target logical IAB-DU). Additionally, or alternatively, the intermediate state 714 may be a state in which the IAB-MT is migrated to the target IAB donor CU, and the associated IAB-DU may be migrated to the target IAB donor CU after the IAB-MT. In this way, a gradual (e.g., bottom-up or top-down) approach to inter-donor migration may mitigate and/or avoid the potential signaling storm associated with inter-donor topology adaptation and/or support traffic flow without packet loss, among other examples.

Referring to FIG. 7B, and example 750, in an initial (pre-migration) state 760, the migrating IAB node that includes the migrating IAB-MT (MT₃) and the migrating IAB-DU (DU₃ₐ) may include a child IAB node serving a UE. Accordingly, in this case, a child IAB node may be in the sub-tree associated with the migrating IAB node. For example, as shown, the migrating IAB-DU (DU₃ₐ) has a first F1 connection to the source IAB donor CU, and the IAB-DU of the IAB child node (DU₄ₐ) has a second F1 connection to the source IAB donor CU. As further shown in FIG. 7B, in a final (post-migration) state 762, the migrating IAB node, the child IAB node of the migrating IAB node, and the UE served by the child IAB node are all connected to the target IAB donor CU. Accordingly, in the final post-migration state 762, the DU of the migrating IAB node and the DU of the child IAB node each have an F1 connection to the target IAB donor CU. In this case, to reduce the signaling associated with the inter-donor migration, intermediate states 764, 766 may be used to gradually migrate served UEs and/or descendant IAB nodes in the sub-tree associated with the migrating IAB node.

For example, in a first intermediate state 764, a descendant UE in the sub-tree associated with the migrating IAB node and a descendant IAB-DU (DU_{4b}) that is serving the descendant UE may be migrated to the target IAB donor CU. In the first intermediate state 764, the migrating IAB-DU (DU₃ₐ) may still have an F1 connection to the source IAB donor CU, and the descendant IAB-DU may have an F1 connection to the target IAB donor CU. Furthermore, in a second intermediate state 766, which may occur a time period (e.g., 30 or 60 minutes) after the inter-donor migration in the first intermediate state 764, an IAB-MT associated with the descendant IAB-DU that was migrated in the first intermediate state 764 may be migrated to the target IAB donor CU together with a logical instance of a DU (DU_{3b}) that is serving the IAB-MT associated with the descendant IAB-DU. In the second intermediate state 766, the DU of the migrating IAB node and the DU of the descendant IAB nodes each have an F1 connection to the target IAB donor CU, while the migrating IAB-MT remains connected to the source IAB donor CU. Accordingly, the migrating IAB-MT may then be migrated to the target IAB donor CU to complete the inter-donor topology adaptation a time period after the inter-donor migration in the second intermediate state 766. Alternatively, in a top-down approach, MT₃ may be migrated to the target IAB donor CU before DU₃, and MT₄ may then be migrated to the target IAB donor CU before DU₄. In this way, a gradual (e.g., bottom-up or top-down) approach to inter-donor migration may mitigate and/or avoid the potential signaling storm associated with inter-donor topology adaptation and/or support traffic flow without packet loss, among other examples.

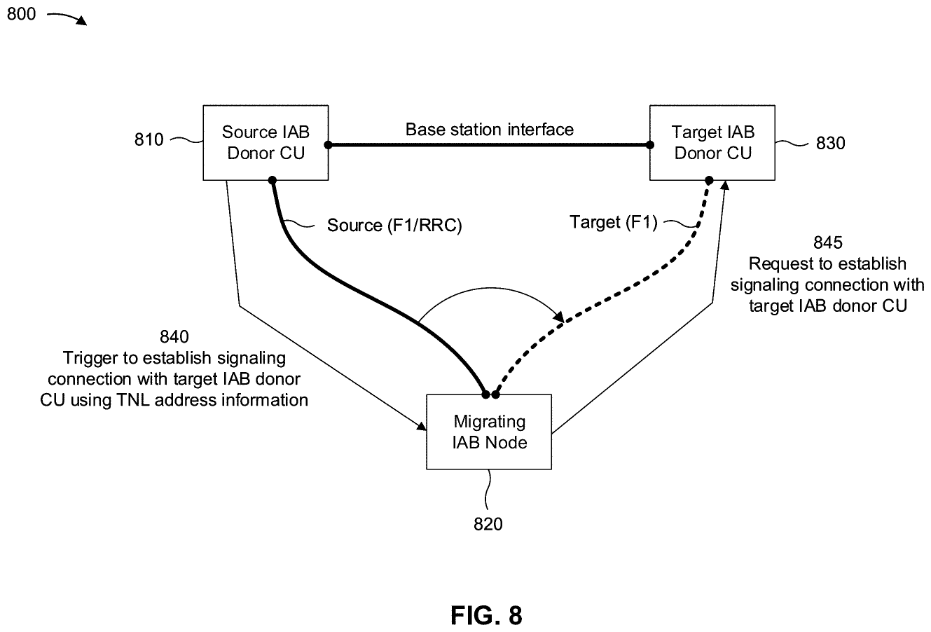

Accordingly, as described above, migration to enable inter-donor topology adaptation may be performed in a gradual manner to spread out the signaling associated with migrating an IAB-MT to a different IAB donor along with any descendant IAB-MT(s) and/or UE(s) that are in a sub-tree under the IAB-MT. For example, in some aspects, a descendant UE and/or a descendant IAB-MT may be migrated to the target IAB donor first along with an IAB-DU that is a parent of the descendant UE and/or the descendant IAB-MT migrated to the target IAB donor. Furthermore, in cases where there are multiple IAB nodes in the sub-tree, the IAB-MT that is a parent of the previously migrated IAB-DU may be migrated to the target IAB donor. However, to migrate each IAB-DU to the target IAB donor, an F1 connection may be established between the IAB-DU and the target IAB donor, which generally requires that a TNL association exist between the IAB-DU and the target IAB donor. Accordingly, some aspects described herein relate to signaling to trigger an IAB-DU to connect to a target IAB donor while the IAB-DU is under an IAB-MT connected to a source IAB donor. Further details relating to the signaling to trigger the inter-donor migration for an IAB-DU are provided below with reference to FIG. 8.

As indicated above, FIGS. 7A-7B are provided as examples. Other examples may differ from what is described with regard to FIGS. 7A-7B.

FIG. 8 is a diagram illustrating an example 800 associated with triggering migration to enable inter-donor topology adaptation in a wireless network, in accordance with the present disclosure. As shown in FIG. 8, example 800 includes a source IAB donor CU 810 that may have a first signaling connection (e.g., a source F1-C connection or a source radio resource control (RRC) connection) with an IAB node 820 to be migrated to a target IAB donor CU 830. For example, the IAB node 820 to be migrated (referred to hereinafter as migrating IAB node 820) may include an IAB-MT and an IAB-DU, and the source IAB donor CU may trigger the migrating IAB node 820 to establish a second signaling connection (e.g., a target F1-C connection) between the IAB-DU and the target IAB donor CU 830 while the IAB-MT is connected to the source IAB donor CU (e.g., via an NR Uu interface providing a direct connection to an IAB donor DU or an indirect connection to the IAB donor DU via one or more intermediate IAB nodes).

In this way, the migrating IAB node 820 may be moved from the source IAB donor CU 810 to the target IAB donor CU 830 in a gradual, bottom-up manner. For example, after the second signaling connection is established between the migrating IAB node 820 and the target IAB donor CU 830, a served UE and/or a child IAB-MT in a sub-tree under the migrating IAB node 820 may be migrated to the DU of the migrating IAB node 820, and F1-U traffic associated with the served UE and/or the child IAB-MT may be backhauled over the second signaling connection.

Accordingly, as shown by reference number 840, the source IAB donor CU 810 may transmit, and the migrating IAB node 820 may receive, a trigger to establish the second signaling connection (e.g., an F1 connection) with the target IAB donor CU 830. For example, as described herein, the trigger may generally cause the DU of the migrating IAB node 820 to initiate an F1 setup procedure with the target IAB donor CU 830. However, as described above, the DU of the migrating IAB node 820 can transmit an F1 setup request message to initiate the F1 setup procedure only after a TNL association has become operational between the DU of the migrating IAB node 820 and the target IAB donor CU 830. Accordingly, in some aspects, the source IAB donor CU 810 may transmit, to the migrating IAB node 820, TNL address information (e.g., IP address information) associated with the target IAB donor CU 830. For example, in some aspects, the source IAB donor CU 810 may transmit the trigger for establishing the second signaling connection and/or the TNL address information associated with the target IAB donor CU 830 to the migrating IAB node 820 over the first signaling connection. For example, in some aspects, the first signaling connection may be an F1-C connection between the DU of the migrating IAB node 820 and the source IAB donor CU 810. Additionally, or alternatively, the first signaling connection may be an RRC signaling connection between the MT of the migrating IAB node 820 and the source IAB donor CU 810. In this way, the migrating IAB node 820 may use the TNL address information to establish a TNL association with the target IAB donor CU 830 and then initiate the F1 setup procedure.

Accordingly, as shown by reference number 845, the migrating IAB node 820 may transmit, to the target IAB donor CU 830, a request to initiate establishment of the second signaling connection, which may be an F1-C signaling connection between the DU of the migrating IAB node 820 and the target IAB donor CU 830, based at least in part on the trigger. For example, the migrating IAB node 820 may use the TNL address information received from the source IAB donor CU 810 to establish one or more TNL associations with the target IAB donor CU 830. In the example, the DU of the migrating IAB node 820 may then transmit an F1 setup request to the target IAB donor CU 830 using the one or more TNL associations in order to establish the second signaling connection (e.g., the F1-C signaling connection with the target IAB donor CU 830).

In some aspects, after the second signaling connection is established between the migrating IAB node 820 and the target IAB donor CU 830, the second signaling connection may be used to exchange F1-C traffic, which may include control signaling for UE-associated traffic and/or control signaling for non-UE associated traffic (e.g., to manage the F1 interface). Additionally, or alternatively, the second signaling connection between the migrating IAB node 820 and the target IAB donor CU 830 may be used to exchange F1-U traffic (e.g., user plane traffic associated with a particular UE or child IAB-MT) and/or non-F1 traffic (e.g., messages that relate to a configuration of the migrating IAB node 820 by a network operator). Accordingly, in some cases, the TNL address information provided from the source IAB donor CU 810 to the migrating IAB node 820 may be the same for different usages (e.g., F1-C, F1-U, and/or non-F1 traffic), or different TNL address information (e.g., different sets of IP addresses) may be provided for the different usages. In some aspects, the source IAB donor CU 810 may indicate the usage(s) associated with the TNL address information that is provided to the migrating IAB node 820.

In some aspects, the source IAB donor CU 810 may receive the TNL address information from the target IAB donor CU 830 over a base station interface. For example, in some aspects, the source IAB donor CU 810 may communicate with the target IAB donor CU 830 over an Xn interface, an X2 interface, and/or another suitable base station interface. Accordingly, in some aspects, the source IAB donor CU 810 may transmit a request for the TNL address information to the target IAB donor CU 830 over the base station interface, and may receive the TNL address information from the target IAB donor CU 830 based at least in part on the request. Additionally, or alternatively, the TNL address information provided to the migrating IAB node 820 may be the same as TNL address information that the source IAB donor CU 810 uses to communicate with the target IAB donor CU 830 over the base station interface.

Furthermore, in some aspects, the source IAB donor CU 810 may indicate a usage for the TNL address information (e.g., UE-associated F1-C traffic, non-UE associated F1-C traffic, F1-U traffic, and/or non-F1 traffic) to the target IAB donor CU 830, or the source IAB donor CU 810 may receive an indication of the usage for the TNL address information from the target IAB donor CU 830. Accordingly, in some aspects, the source IAB donor CU 810 and the target IAB donor CU 830 may communicate over the base station interface to establish or otherwise determine the usage(s) for the TNL address information, and the source IAB donor CU 810 may indicate the usage(s) to the migrating IAB node 820 to enable inter-donor migration to the target IAB donor CU 830. Additionally, or alternatively, the migrating IAB node 820 may transmit, and the source IAB donor CU 810 may receive, a request for the TNL address information over the first signaling connection. In this case, the migrating IAB node 820 may indicate the usage(s) for the requested TNL address information, and/or the source IAB donor CU 810 may provide the TNL address information associated with the target IAB donor CU 830 to the migrating IAB node 820 based at least in part on the request.

In this way, the migrating IAB node 820 may use the TNL address information provided by the source IAB donor CU 810 to establish a TNL association with the target IAB donor CU 830 in order to establish IP connectivity with the target IAB donor CU 830. In this way, the migrating IAB node 820 may use the established TNL association to exchange F1AP traffic, and specifically to transmit an F1 setup request message to the target IAB donor CU 830. In this way, the migrating IAB node 820 may establish an F1 connection with the target IAB donor CU 830 while an MT of the migrating IAB node 820 remains connected to the source IAB donor CU 810, whereby the MT of the migrating IAB node 820 may be migrated to the target IAB donor CU 830 at a later time to avoid or mitigate a signaling storm that would otherwise occur if the MT and the DU of the migrating IAB node 820 were to be concurrently migrated to the target IAB donor CU 830 along with any served UEs and/or child IAB nodes in a sub-tree under the migrating IAB node 820.

As indicated above, FIG. 8 is provided as an example. Other examples may differ from what is described with regard to FIG. 8.

FIG. 9 is a diagram illustrating an example process 900 performed, for example, by a source IAB donor CU, in accordance with the present disclosure. Example process 900 is an example where the source IAB donor CU (e.g., IAB-donor 405, IAB-donor-CU 522, and/or source IAB donor CU 810, among other examples) performs operations associated with triggering migration to enable inter-donor topology adaptation in a wireless network.

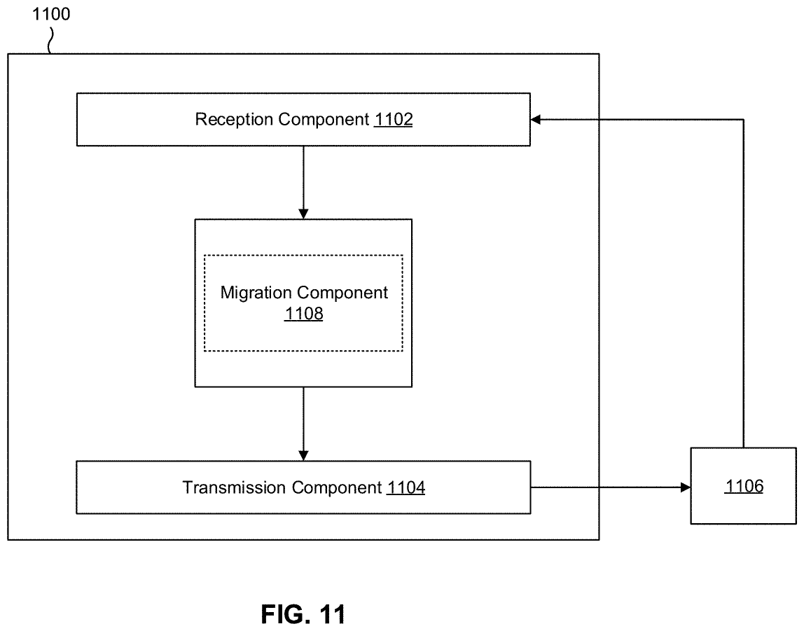

As shown in FIG. 9, in some aspects, process 900 may include transmitting, to an IAB node having a first signaling connection with the source IAB donor CU, a trigger to establish a second signaling connection between the IAB node and a target IAB donor CU (block 910). For example, the IAB (e.g., using transmission component 1104 and/or migration component 1108, depicted in FIG. 11) may transmit, to an IAB node having a first signaling connection with the source IAB donor CU, a trigger to establish a second signaling connection between the IAB node and a target IAB donor CU, as described above.

As further shown in FIG. 9, in some aspects, process 900 may include transmitting, to the IAB node, TNL address information associated with the target IAB donor CU to enable the IAB node to establish the second signaling connection with the target IAB donor CU (block 920). For example, the IAB (e.g., using transmission component 1104 and/or migration component 1108, depicted in FIG. 11) may transmit, to the IAB node, TNL address information associated with the target IAB donor CU to enable the IAB node to establish the second signaling connection with the target IAB donor CU, as described above.

Process 900 may include additional aspects, such as any single aspect or any combination of aspects described below and/or in connection with one or more other processes described elsewhere herein.

In a first aspect, the first signaling connection is an F1-C signaling connection or an RRC signaling connection.

In a second aspect, alone or in combination with the first aspect, the second signaling connection is an F1-C signaling connection.

In a third aspect, alone or in combination with one or more of the first and second aspects, one or more of the trigger or the TNL address information is transmitted to the IAB node over the first signaling connection.

In a fourth aspect, alone or in combination with one or more of the first through third aspects, the TNL address information includes IP address information associated with the target IAB donor CU.

In a fifth aspect, alone or in combination with one or more of the first through fourth aspects, the second signaling connection is associated with one or more of F1-C traffic, F1-U traffic, or non-F1 traffic.

In a sixth aspect, alone or in combination with one or more of the first through fifth aspects, the TNL address information is associated with one or more of the F1-C traffic, the F1-U traffic, or the non-F1 traffic.

In a seventh aspect, alone or in combination with one or more of the first through sixth aspects, process 900 includes transmitting, to the IAB node, information indicating whether the TNL address information is associated with the F1-C traffic, the F1-U traffic, or the non-F1 traffic.

In an eighth aspect, alone or in combination with one or more of the first through seventh aspects, process 900 includes receiving the TNL address information from the target IAB donor CU.

In a ninth aspect, alone or in combination with one or more of the first through eighth aspects, process 900 includes transmitting, to the target IAB donor CU, a request for the TNL address information, wherein the TNL address information is received from the target IAB donor CU based at least in part on the request.

In a tenth aspect, alone or in combination with one or more of the first through ninth aspects, process 900 includes communicating with the target IAB donor CU to establish a usage associated with the TNL address information.

In an eleventh aspect, alone or in combination with one or more of the first through tenth aspects, the TNL address information transmitted to the IAB node is associated with communication over a base station interface between the source IAB donor CU and the target IAB donor CU.

In a twelfth aspect, alone or in combination with one or more of the first through eleventh aspects, process 900 includes receiving a request for the TNL address information from the IAB node over the first signaling connection.

In a thirteenth aspect, alone or in combination with one or more of the first through twelfth aspects, the request indicates a usage associated with the TNL address information.

In a fourteenth aspect, alone or in combination with one or more of the first through thirteenth aspects, the TNL address information is transmitted to the IAB node based at least in part on the request.

In a fifteenth aspect, alone or in combination with one or more of the first through fourteenth aspects, the TNL address information transmitted to the IAB node enables the IAB node to establish a TNL association with the target IAB donor CU.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by an IAB node, in accordance with the present disclosure. Example process 1000 is an example where the IAB node (e.g., IAB-node 410, IAB-node 530, and/or migrating IAB node 820, among other examples) performs operations associated with triggering migration to enable inter-donor topology adaptation in a wireless network.

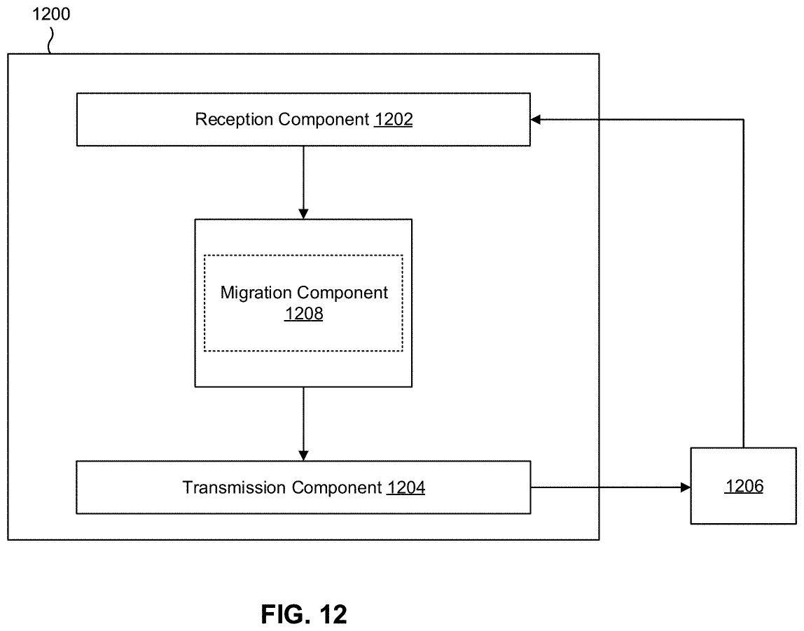

As shown in FIG. 10, in some aspects, process 1000 may include receiving, from a source IAB donor CU having a first signaling connection with the IAB node, a trigger to establish a second signaling connection with a target IAB donor CU (block 1010). For example, the IAB (e.g., using reception component 1202 and/or migration component 1208, depicted in FIG. 12) may receive, from a source IAB donor CU having a first signaling connection with the IAB node, a trigger to establish a second signaling connection with a target IAB donor CU, as described above.

As further shown in FIG. 10, in some aspects, process 1000 may include transmitting, to the target IAB donor CU, a request to establish the second signaling connection with the target IAB donor CU based at least in part on the trigger (block 1020). For example, the IAB (e.g., using transmission component 1204 and/or migration component 1208, depicted in FIG. 12) may transmit, to the target IAB donor CU, a request to establish the second signaling connection with the target IAB donor CU based at least in part on the trigger, as described above.

Process 1000 may include additional aspects, such as any single aspect or any combination of aspects described below and/or in connection with one or more other processes described elsewhere herein.

In a first aspect, process 1000 includes receiving, from the source IAB donor CU, TNL address information associated with the target IAB donor CU over the first signaling connection, wherein the TNL address information is used to establish the second signaling connection with the target IAB donor CU.

In a second aspect, alone or in combination with the first aspect, the TNL address information includes IP address information associated with the target IAB donor CU.

In a third aspect, alone or in combination with one or more of the first and second aspects, the TNL address information is associated with one or more of F1-C traffic, F1-U traffic, or non-F1 traffic.

In a fourth aspect, alone or in combination with one or more of the first through third aspects, process 1000 includes receiving, from the source IAB donor CU, information indicating whether the TNL address information is associated with F1-C traffic, F1-U traffic, or non-F1 traffic.

In a fifth aspect, alone or in combination with one or more of the first through fourth aspects, the TNL address information received from the source IAB donor CU is associated with communication over a base station interface between the source IAB donor CU and the target IAB donor CU.

In a sixth aspect, alone or in combination with one or more of the first through fifth aspects, process 1000 includes transmitting a request for the TNL address information to the source IAB donor CU over the first signaling connection.

In a seventh aspect, alone or in combination with one or more of the first through sixth aspects, the request indicates a usage associated with the TNL address information.

In an eighth aspect, alone or in combination with one or more of the first through seventh aspects, the TNL address information is transmitted to the IAB node based at least in part on the request.

In a ninth aspect, alone or in combination with one or more of the first through eighth aspects, the TNL address information received from the source IAB donor CU enables the IAB node to establish a TNL association with the target IAB donor CU.

In a tenth aspect, alone or in combination with one or more of the first through ninth aspects, the first signaling connection is an F1-C signaling connection or an RRC signaling connection.

In an eleventh aspect, alone or in combination with one or more of the first through tenth aspects, the second signaling connection is an F1-C signaling connection.

In a twelfth aspect, alone or in combination with one or more of the first through eleventh aspects, the second signaling connection is associated with one or more of F1-C traffic, F1-U traffic, or non-F1 traffic.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication. The apparatus 1100 may be an IAB donor CU, or an IAB donor CU may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, an IAB node, another IAB donor CU, or another wireless communication device) using the reception component 1102 and the transmission component 1104. As further shown, the apparatus 1100 may include a migration component 1108, among other examples.

In some aspects, the apparatus 1100 may be configured to perform one or more operations described herein in connection with FIGS. 7A-7B and/or FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The transmission component 1104 may transmit, or the migration component 1108 may cause the transmission component 1104 to transmit, to an IAB node having a first signaling connection with the source IAB donor CU, a trigger to establish a second signaling connection between the IAB node and a target IAB donor CU. The transmission component 1104 may transmit, to the IAB node, TNL address information associated with the target IAB donor CU to enable the IAB node to establish the second signaling connection with the target IAB donor CU.

The transmission component 1104 may transmit, or the migration component 1108 may cause the transmission component 1104 to transmit, to the IAB node, information indicating whether the TNL address information is associated with F1-C traffic, F1-U traffic, or non-F1 traffic.

The reception component 1102 may receive, or the migration component 1108 may cause the reception component 1102 to receive, the TNL address information from the target IAB donor CU.

The transmission component 1104 may transmit, or the migration component 1108 may cause the transmission component 1104 to transmit, to the target IAB donor CU, a request for the TNL address information, wherein the TNL address information is received from the target IAB donor CU based at least in part on the request.

The reception component 1102 and/or the transmission component 1104 may communicate, or the migration component 1108 may cause the reception component 1102 and/or the transmission component 1104 to communicate, with the target IAB donor CU to establish a usage associated with the TNL address information.

The reception component 1102 may receive, or the migration component 1108 may cause the reception component 1102 to receive, a request for the TNL address information from the IAB node over the first signaling connection.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be an IAB node, or an IAB node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, an IAB donor CU, another IAB node, or another wireless communication device) using the reception component 1202 and the transmission component 1204. As further shown, the apparatus 1200 may include a migration component 1208, among other examples.

In some aspects, the apparatus 1200 may be configured to perform one or more operations described herein in connection with FIGS. 7A-7B and/or FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The reception component 1202 may receive, or the migration component 1208 may cause the reception component 1202 to receive, from a source IAB donor CU having a first signaling connection with the IAB node, a trigger to establish a second signaling connection with a target IAB donor CU. The transmission component 1204 may transmit, or the migration component 1208 may cause the transmission component 1204 to transmit, to the target IAB donor CU, a request to establish the second signaling connection with the target IAB donor CU based at least in part on the trigger.

The reception component 1202 may receive, or the migration component 1208 may cause the reception component 1202 to receive, from the source IAB donor CU, TNL address information associated with the target IAB donor CU over the first signaling connection, wherein the TNL address information is used to establish the second signaling connection with the target IAB donor CU.

The reception component 1202 may receive, or the migration component 1208 may cause the reception component 1202 to receive, from the source IAB donor CU, information indicating whether the TNL address information is associated with F1-C traffic, F1-U traffic, or non-F1 traffic.

The transmission component 1204 may transmit, or the migration component 1208 may cause the transmission component 1204 to transmit, a request for the TNL address information to the source IAB donor CU over the first signaling connection.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a source IAB donor CU, comprising: transmitting, to an IAB node having a first signaling connection with the source IAB donor CU, a trigger to establish a second signaling connection between the IAB node and a target IAB donor CU; and transmitting, to the IAB node, TNL address information associated with the target IAB donor CU to enable the IAB node to establish the second signaling connection with the target IAB donor CU.

Aspect 2: The method of Aspect 1, wherein the first signaling connection is an F1-C signaling connection or an RRC signaling connection.

Aspect 3: The method of any of Aspects 1-2, wherein the second signaling connection is an F1-C signaling connection.

Aspect 4: The method of any of Aspects 1-3, wherein one or more of the trigger or the TNL address information is transmitted to the IAB node over the first signaling connection.

Aspect 5: The method of any of Aspects 1-4, wherein the TNL address information includes IP address information associated with the target IAB donor CU.

Aspect 6: The method of any of Aspects 1-5, wherein the second signaling connection is associated with one or more of F1-C traffic, F1-U traffic, or non-F1 traffic.

Aspect 7: The method of Aspect 6, wherein the TNL address information is associated with one or more of the F1-C traffic, the F1-U traffic, or the non-F1 traffic.

Aspect 8: The method of any of Aspects 6-7, further comprising: transmitting, to the IAB node, information indicating whether the TNL address information is associated with the F1-C traffic, the F1-U traffic, or the non-F1 traffic.

Aspect 9: The method of any of Aspects 1-8, further comprising: receiving the TNL address information from the target IAB donor CU.

Aspect 10: The method of Aspect 9, further comprising: transmitting, to the target IAB donor CU, a request for the TNL address information, wherein the TNL address information is received from the target IAB donor CU based at least in part on the request.

Aspect 11: The method of any of Aspects 9-10, further comprising: communicating with the target IAB donor CU to establish a usage associated with the TNL address information.

Aspect 12: The method of any of Aspects 1-11, wherein the TNL address information transmitted to the IAB node is associated with communication over a base station interface between the source IAB donor CU and the target IAB donor CU.

Aspect 13: The method of any of Aspects 1-12, further comprising: receiving a request for the TNL address information from the IAB node over the first signaling connection.

Aspect 14: The method of Aspect 13, wherein the request indicates a usage associated with the TNL address information.

Aspect 15: The method of any of Aspects 13-14, wherein the TNL address information is transmitted to the IAB node based at least in part on the request.

Aspect 16: The method of any of Aspects 1-15, wherein the TNL address information transmitted to the IAB node enables the IAB node to establish a TNL association with the target IAB donor CU.

Aspect 17: A method of wireless communication performed by an IAB node, comprising: receiving, from a source IAB donor CU having a first signaling connection with the IAB node, a trigger to establish a second signaling connection with a target IAB donor CU; and transmitting, to the target IAB donor CU, a request to establish the second signaling connection with the target IAB donor CU based at least in part on the trigger.

Aspect 18: The method of Aspect 17, further comprising: receiving, from the source IAB donor CU, TNL address information associated with the target IAB donor CU over the first signaling connection, wherein the TNL address information is used to establish the second signaling connection with the target IAB donor CU.

Aspect 19: The method of Aspect 18, wherein the TNL address information includes IP address information associated with the target IAB donor CU.

Aspect 20: The method of any of Aspects 18-19, wherein the TNL address information is associated with one or more of F1-C traffic, F1-U traffic, or non-F1 traffic.

Aspect 21: The method of any of Aspects 18-20, further comprising: receiving, from the source IAB donor CU, information indicating whether the TNL address information is associated with F1-C traffic, F1-U traffic, or non-F1 traffic.

Aspect 22: The method of any of Aspects 18-21, wherein the TNL address information received from the source IAB donor CU is associated with communication over a base station interface between the source IAB donor CU and the target IAB donor CU.

Aspect 23: The method of any of Aspects 18-22, further comprising: transmitting a request for the TNL address information to the source IAB donor CU over the first signaling connection.

Aspect 24: The method of Aspect 23, wherein the request indicates a usage associated with the TNL address information.

Aspect 25: The method of any of Aspects 23-24, wherein the TNL address information is transmitted to the IAB node based at least in part on the request.

Aspect 26: The method of any of Aspects 18-25, wherein the TNL address information received from the source IAB donor CU enables the IAB node to establish a TNL association with the target IAB donor CU.

Aspect 27: The method of any of Aspects 17-26, wherein the first signaling connection is an F1-C signaling connection or an RRC signaling connection.

Aspect 28: The method of any of Aspects 17-27, wherein the second signaling connection is an F1-C signaling connection.

Aspect 29: The method of any of Aspects 17-28, wherein the second signaling connection is associated with one or more of F1-C traffic, F1-U traffic, or non-F1 traffic.

Aspect 30: An apparatus for wireless communication at a device, comprising a processor; memory coupled with the processor; and instructions stored in the memory and executable by the processor to cause the apparatus to perform the method of one or more of Aspects 1-16.

Aspect 31: A device for wireless communication, comprising a memory and one or more processors coupled to the memory, the one or more processors configured to perform the method of one or more of Aspects 1-16.

Aspect 32: An apparatus for wireless communication, comprising at least one means for performing the method of one or more of Aspects 1-16.

Aspect 33: A non-transitory computer-readable medium storing code for wireless communication, the code comprising instructions executable by a processor to perform the method of one or more of Aspects 1-16.

Aspect 34: A non-transitory computer-readable medium storing a set of instructions for wireless communication, the set of instructions comprising one or more instructions that, when executed by one or more processors of a device, cause the device to perform the method of one or more of Aspects 1-16.

Aspect 35: An apparatus for wireless communication at a device, comprising a processor; memory coupled with the processor; and instructions stored in the memory and executable by the processor to cause the apparatus to perform the method of one or more of Aspects 17-29.

Aspect 36: A device for wireless communication, comprising a memory and one or more processors coupled to the memory, the one or more processors configured to perform the method of one or more of Aspects 17-29.

Aspect 37: An apparatus for wireless communication, comprising at least one means for performing the method of one or more of Aspects 17-29.

Aspect 38: A non-transitory computer-readable medium storing code for wireless communication, the code comprising instructions executable by a processor to perform the method of one or more of Aspects 17-29.

Aspect 39: A non-transitory computer-readable medium storing a set of instructions for wireless communication, the set of instructions comprising one or more instructions that, when executed by one or more processors of a device, cause the device to perform the method of one or more of Aspects 17-29.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a source integrated access and backhaul (IAB) donor central unit (CU), comprising:
transmitting, to an IAB node having a first signaling connection with the source IAB donor CU, a trigger to establish a second signaling connection between the IAB node and a target IAB donor CU; and
transmitting, to the IAB node, transport network layer (TNL) address information associated with the target IAB donor CU to enable the IAB node to establish the second signaling connection with the target IAB donor CU.

2. The method of claim 1, wherein the first signaling connection is an F1-C signaling connection or a radio resource control signaling connection.

3. The method of claim 1, wherein the second signaling connection is an F1-C signaling connection.

4. The method of claim 1, wherein one or more of the trigger or the TNL address information is transmitted to the IAB node over the first signaling connection.

5. The method of claim 1, wherein the TNL address information includes Internet Protocol address information associated with the target IAB donor CU.

6. The method of claim 1, wherein the second signaling connection is associated with one or more of F1-C traffic, F1-U traffic, or non-F1 traffic.

7. The method of claim 6, wherein the TNL address information is associated with one or more of the F1-C traffic, the F1-U traffic, or the non-F1 traffic.

8. The method of claim 6, further comprising:
transmitting, to the IAB node, information indicating whether the TNL address information is associated with the F1-C traffic, the F1-U traffic, or the non-F1 traffic.

9. The method of claim 1, further comprising:
receiving the TNL address information from the target IAB donor CU.

10. The method of claim 9, further comprising:
transmitting, to the target IAB donor CU, a request for the TNL address information, wherein the TNL address information is received from the target IAB donor CU based at least in part on the request.

11. The method of claim 9, further comprising:
communicating with the target IAB donor CU to establish a usage associated with the TNL address information.

12. The method of claim 1, wherein the TNL address information transmitted to the IAB node is associated with communication over a base station interface between the source IAB donor CU and the target IAB donor CU.

13. The method of claim 1, further comprising:
receiving a request for the TNL address information from the IAB node over the first signaling connection.

14. The method of claim 13, wherein the request indicates a usage associated with the TNL address information.

15. The method of claim 13, wherein the TNL address information is transmitted to the IAB node based at least in part on the request.

16. The method of claim 1, wherein the TNL address information transmitted to the IAB node enables the IAB node to establish a TNL association with the target IAB donor CU.

17. A method of wireless communication performed by an integrated access and backhaul (IAB) node, comprising:
receiving, from a source IAB donor CU having a first signaling connection with the IAB node, a trigger to establish a second signaling connection with a target IAB donor CU; and
transmitting, to the target IAB donor CU, a request to establish the second signaling connection with the target IAB donor CU based at least in part on the trigger.

18. The method of claim 17, further comprising:
receiving, from the source IAB donor CU, transport network layer (TNL) address information associated with the target IAB donor CU over the first signaling connection, wherein the TNL address information is used to establish the second signaling connection with the target IAB donor CU.

19. The method of claim 18, wherein the TNL address information includes Internet Protocol address information associated with the target IAB donor CU.

20. The method of claim 18, wherein the TNL address information is associated with one or more of F1-C traffic, F1-U traffic, or non-F1 traffic.

21. The method of claim 18, further comprising:
receiving, from the source IAB donor CU, information indicating whether the TNL address information is associated with F1-C traffic, F1-U traffic, or non-F1 traffic.

22. The method of claim 18, wherein the TNL address information received from the source IAB donor CU is associated with communication over a base station interface between the source IAB donor CU and the target IAB donor CU.

23. The method of claim 18, further comprising:
transmitting a request for the TNL address information to the source IAB donor CU over the first signaling connection.

24. The method of claim 23, wherein the request indicates a usage associated with the TNL address information.

25. The method of claim 23, wherein the TNL address information is transmitted to the IAB node based at least in part on the request.

26. The method of claim 18, wherein the TNL address information received from the source IAB donor CU enables the IAB node to establish a TNL association with the target IAB donor CU.

27. The method of claim 17, wherein the first signaling connection is an F1-C signaling connection or a radio resource control signaling connection.

28. The method of claim 17, wherein the second signaling connection is an F1-C signaling connection associated with one or more of F1-C traffic, F1-U traffic, or non-F1 traffic.

29. A source integrated access and backhaul (IAB) donor central unit (CU) for wireless communication, comprising:
a memory; and
one or more processors, coupled to the memory, configured to:
transmit, to an IAB node having a first signaling connection with the source IAB donor CU, a trigger to establish a second signaling connection between the IAB node and a target IAB donor CU; and
transmit, to the IAB node, transport network layer (TNL) address information associated with the target IAB donor CU to enable the IAB node to establish the second signaling connection with the target IAB donor CU.

30. An integrated access and backhaul (IAB) node for wireless communication, comprising:
a memory; and
one or more processors, coupled to the memory, configured to:
receive, from a source IAB donor CU having a first signaling connection with the IAB node, a trigger to establish a second signaling connection with a target IAB donor CU; and
transmit, to the target IAB donor CU, a request to establish the second signaling connection with the target IAB donor CU based at least in part on the trigger.
